(19) United States
(12) Patent Application Publication
(10) Pub. No.: US 2024/0121371 A1
(43) Pub. Date: Apr. 11, 2024

(54) METHOD OF GENERATING MICRO IMAGE AND APPARATUS THEREFOR

(71) Applicant: INHA UNIVERSITY RESEARCH AND BUSINESS FOUNDATION, Incheon (KR)

(72) Inventors: Chae Eun RHEE, Seoul (KR); Hyun Min Jung, Seoul (KR)

(73) Assignee: INHA UNIVERSITY RESEARCH AND BUSINESS FOUNDATION, Incheon (KR)

(21) Appl. No.: 18/480,285

(22) Filed: Oct. 3, 2023

(30) Foreign Application Priority Data
Oct. 7, 2022 (KR) 10-2022-0129045

(51) Int. Cl. H04N 13/161; G06T 7/50

(52) U.S. Cl. CPC H04N 13/161; G06T 7/50; H04N 2013/0081

(57) ABSTRACT

An image processing method includes obtaining a plurality of main images for a plurality of light field images captured from different viewpoints, generating a depth map representing depth information of the plurality of light field images, based on the plurality of main images, generating a plurality of prediction images for the plurality of light field images, based on the plurality of main images, generating a plurality of residual images representing a difference between the plurality of light field images and the plurality of prediction images, and generating a micro image based on the depth map and the plurality of residual images.

### CROSS-REFERENCE TO RELATED APPLICATION

This application is based on and claims priority under 35 U.S.C. § 119 to Korean Patent Application No. 10-2022-0129045, filed on Oct. 7, 2022, in the Korean Intellectual Property Office, the disclosure of which is incorporated by reference herein in its entirety.

### BACKGROUND

### 1. Field

The disclosure relates to a method of generating a micro image and an apparatus therefor. More particularly, the disclosure relates to a method of generating a micro image by using a plurality of light field images captured from different viewpoints and an apparatus therefor.

### 2. Description of the Related Art

Light fields refer to fields for expressing the intensity and direction of light reflected from subjects in three-dimensional spaces. Light fields, which are an approach to three-dimensional image processing, are based on large amounts of data. Therefore, there is a need for a method of image compression in the field of light fields.

### SUMMARY

Additional aspects will be set forth in part in the description which follows and, in part, will be apparent from the description, or may be learned by practice of the presented embodiments of the disclosure.

According to an aspect of the disclosure, provided is an image processing method. The image processing method may include obtaining a plurality of main images for a plurality of light field images captured from different viewpoints. The image processing method may include generating a depth map representing depth information of the plurality of light field images, based on the plurality of main images. The image processing method may include generating a plurality of prediction images for the plurality of light field images, based on the plurality of main images. The image processing method may include generating a plurality of residual images representing a difference between the plurality of light field images and the plurality of prediction images. The image processing method may include generating a micro image based on the depth map and the plurality of residual images.

The generating of the depth map may include identifying a second pixel of a second main image corresponding to a first pixel of a first main image. The generating of the depth map may include generating the depth map based on a difference between a location of the first pixel and a location of the second pixel. Each of the first main image and the second main image may include one of the plurality of main images.

The image processing method may further include adjusting a value of the depth map to an integer.

The generating of the micro image may include generating a synthesized image by arranging the plurality of residual images to correspond to different viewpoints at which the plurality of light field images are captured. The generating of the micro image may include generating a micro image by arranging the synthesized image by using the depth map.

The generating of the micro image by arranging the synthesized image by using the depth map may include generating the micro image by adjusting a location of a pixel of the synthesized image based on a value of the depth map corresponding to the pixel of the synthesized image.

The generating of the micro image by arranging the synthesized image by using the depth map may include performing a horizontal arrangement indicating an arrangement between pixels present in a same row of the synthesized image.

The generating of the micro image by arranging the synthesized image by using the depth map may include performing a vertical arrangement indicating an arrangement between pixels present in a same column of the synthesized image.

The image processing method may further include encoding the micro image.

The image processing method may further include encoding a plurality of original main images corresponding to the plurality of main images, from among the plurality of light field images. The image processing method may further include transmitting information regarding the encoded micro image and information regarding the encoded original main images.

The obtaining of the plurality of main images may include encoding a plurality of original main images corresponding to the plurality of main images, from among the plurality of light field images. The obtaining of the plurality of main images may include obtaining the plurality of main images by decoding the plurality of encoded original main images.

According to another aspect of the disclosure, provided is an image processing apparatus including a memory configured to store at least one instruction, and at least one processor operating according to the at least one instruction. The at least one processor may be configured to obtain a plurality of main images for a plurality of light field images captured from different viewpoints. The at least one processor may be configured to generate, based on the plurality of main images, a depth map representing depth information of the plurality of light field images. The at least one processor may be configured to generate, based on the plurality of main images, a plurality of prediction images for the plurality of light field images. The at least one processor may be configured to generate a plurality of residual images representing a difference between the plurality of light field images and the plurality of prediction images. The at least one processor may be configured to generate a micro image based on the depth map and the plurality of residual images.

The at least one processor may be configured to identify a second pixel of a second main image corresponding to a first pixel of a first main image. The at least one processor may be configured to generate the depth map based on a difference between a location of the first pixel and a location of the second pixel. Each of the first main image and the second main image may include one of the plurality of main images.

The at least one processor may be configured to adjust a value of the depth map to an integer.

The at least one processor may be configured to generate a synthesized image by arranging the plurality of residual images to correspond to different viewpoints at which the plurality of light field images are captured. The at least one processor may be configured to generate a micro image by arranging the synthesized image by using the depth map.

The at least one processor may be configured to generate the micro image by adjusting a location of a pixel of the synthesized image based on a value of the depth map corresponding to the pixel of the synthesized image.

The at least one processor may be configured to perform a horizontal arrangement indicating an arrangement between pixels present in a same row of the synthesized image.

The at least one processor may be configured to perform a vertical arrangement indicating an arrangement between pixels present in a same column of the synthesized image.

The at least one processor may be configured to encode the micro image.

The at least one processor may be configured to encode a plurality of original main images corresponding to the plurality of main images, from among the plurality of light field images. The at least one processor may be configured to transmit information regarding the encoded micro image and information regarding the encoded original main images.

According to another aspect of the disclosure, provided is a computer-readable recording medium having recorded thereon a program for performing the method in a computer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a method of generating a micro image for a light field image, according to an embodiment;

FIG. 2 is a diagram illustrating a method of obtaining a light field image, according to an embodiment;

FIG. 3 is a diagram illustrating a method of obtaining a light field image, according to an embodiment;

FIG. 4 is a diagram illustrating a depth map, according to an embodiment;

FIG. 5 is a diagram illustrating a method of generating a light field prediction image based on a main image, according to an embodiment;

FIG. 6 is a diagram illustrating a method of generating a residual image, according to an embodiment;

FIG. 7 is a diagram illustrating a structure of a micro image according to a related art;

FIG. 8 is a diagram illustrating a method of generating a micro image, according to a related art;

FIG. 9 is a diagram illustrating a method of generating a micro image, according to a related art;

FIG. 10 is a diagram illustrating a method of generating a micro image, according to an embodiment;

FIG. 11 is a diagram illustrating a method of generating a micro image, according to an embodiment;

FIG. 12 is a flowchart illustrating an image processing method according to an embodiment;

FIG. 13 is a flowchart of a method of generating a micro image based on a flag, according to an embodiment;

FIG. 14 is a block diagram illustrating a structure of an image processing apparatus according to an embodiment;

FIG. 15 is a flowchart of a method of generating a light field reconstruction image from a micro image, according to an embodiment; and

FIG. 16 is a block diagram illustrating a structure of an image processing apparatus according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Since the disclosure may make various changes and have various embodiments, particular embodiments will be illustrated in the drawings and described in detail through the description. However, this is not intended to limit the embodiments, and it should be understood that the disclosure includes all changes, equivalents, or alternatives included in the spirit and scope of various embodiments.

When describing an embodiment, a detailed description of the related known art, which may unnecessarily obscure the gist of the disclosure, will be omitted. In addition, numbers (e.g., first, second, etc.) used in the description are only identification symbols to distinguish one component from another.

In addition, when one component is referred to as being “coupled to” or “connected to” to another component herein, it should be understood that the one component may be directly coupled to or directly connected to the other component, but may be coupled or connected through another intervening component unless there is a particular contrary description.

In addition, as used herein, components expressed as “˜part (unit)”, “module”, etc. may be two or more components combined into one component, or may be one component divided into two or more for each more subdivided function. In addition, each component described below may additionally perform some or all of functions of other components, in addition to a main function thereof, and some of main functions of respective components may be exclusively performed by other components.

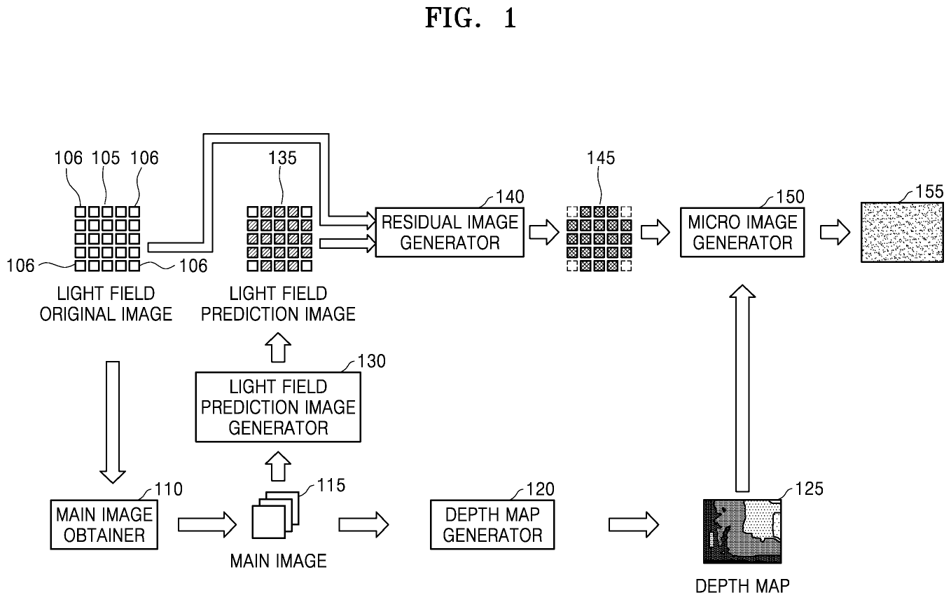

FIG. 1 is a diagram illustrating a method of generating a micro image for a light field image, according to an embodiment.

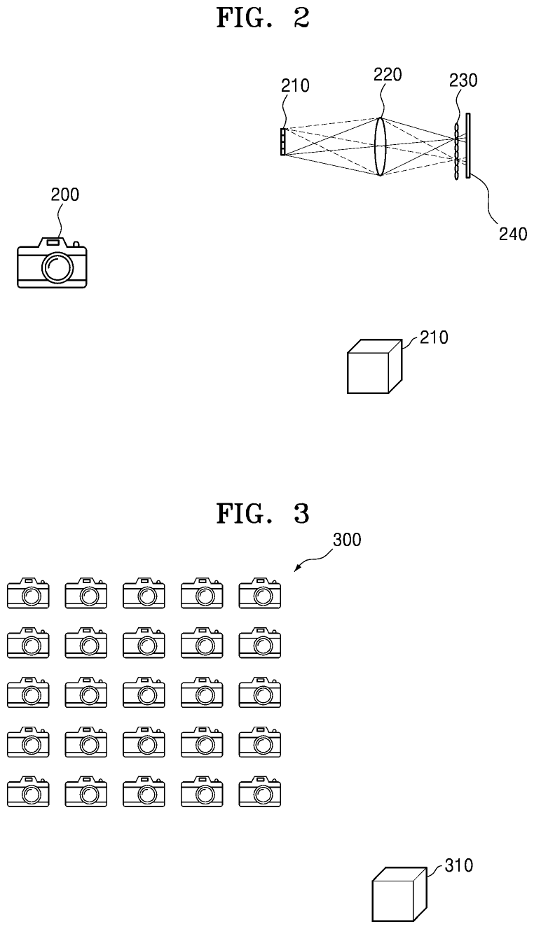

Referring to FIG. 1, an image processing apparatus 100 may generate a micro image 155 based on a light field original image 105. According to an embodiment, the light field original image 105 may be a plurality of images captured from different viewpoints. For example, squares included in the light field original image 105 may indicate respective images captured from different viewpoints, and locations of the images may be arranged in correspondence to the captured viewpoints. According to an embodiment, the light field original image 105 may be obtained by a light field image obtaining method described below with reference to FIG. 2 or a light field image obtaining method described below with reference to FIG. 3, but is not limited thereto and may be obtained in various methods.

According to an embodiment, the light field original image 105 may include 25 images obtained from cameras or sensors arranged in a 5×5 location. A method of obtaining a light field original image, according to an embodiment, is described below in more detail with reference to FIGS. 2 and 3.

A main image obtainer 110 may obtain a main image 115 from the light field original image 105. According to an embodiment, the main image 115 may be obtained from at least a portion of the light field original image 105. For example, the main image 115 may be a partial image of the light field original image 105.

According to an embodiment, the main image 115 may be obtained by encoding and decoding at least a portion of the light field original image 105. For example, the main image 115 may be an image reconstructed by encoding and decoding some images 106 from among the light field original image 105.

According to an embodiment, an encoding and decoding method may use at least one of H.264, high efficiency video coding (HEVC), versatile video coding (VVC), and AOMedia video (AV1), but is not limited thereto and may use various types of video compression formats.

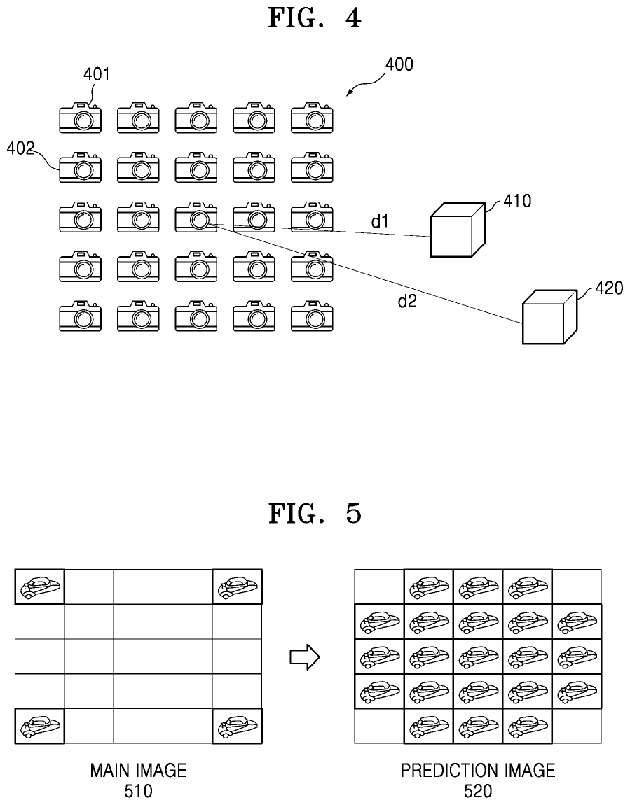

A depth map generator 120 may generate a depth map 125 based on the main image 115. The depth map 125 may include depth information of a region included in the main image 115 or the light field original image 105. According to an embodiment, the depth map 125 may have the same resolution as a residual image 145 described below. According to an embodiment, a method of generating the depth map 125 is described below in more detail with reference to FIG. 4.

A light field prediction image generator 130 may generate a light field prediction image 135 based on the main image 115. According to an embodiment, the light field prediction image 135 may have the captured viewpoints with an equal distribution, and thus may be generated based on the main image 115. According to an embodiment, from among the light field prediction image 135, an image corresponding to the main image 115 may not be separately generated, and the main image 115 may be used. According to an embodiment, a method of generating the light field prediction image 135 based on the main image 115 is described below in more detail with reference to FIG. 5.

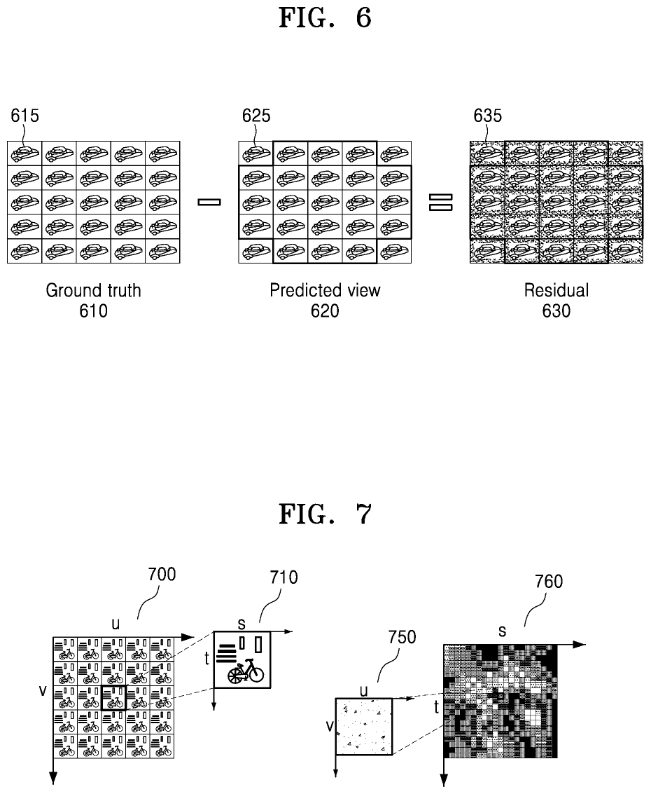

A residual image generator 140 may generate the residual image 145 based on the light field original image 105 and the light field prediction image 135. According to an embodiment, the residual image 145 may be generated based on a difference between the light field original image 105 and the light field prediction image 135. According to an embodiment, a method of generating the residual image 145 is described below in more detail with reference to FIG. 6.

A micro image generator 150 may generate the micro image 155 based on the depth map 125 and the residual image 145. According to an embodiment, the micro image 155 may be generated by arranging the residual image 145 based on a value of the depth map 125 corresponding to a pixel of the residual image 145. A method of generating a micro image, according to an embodiment, is described below in more detail with reference to FIGS. 7 to 11.

FIG. 2 is a diagram illustrating a method of obtaining a light field image, according to an embodiment.

Referring to FIG. 2, a camera 200 may obtain a light field image by photographing an object 210. According to an embodiment, the camera 200 may include a main lens 220 and a microlens array 230. Light from the object 210 may pass through the main lens 220 and the microlens array 230 and generate an image on an image plane.

According to an embodiment, the microlens array 230 may include a plurality of microlenses. An image of the object 210 corresponding to each of the plurality of microlenses may be generated. Images respectively generated by the plurality of microlenses may obtain the same effect as those captured at different viewpoints. Therefore, the camera 200 may obtain a plurality of light field images captured at different viewpoints by using the main lens 220 and the microlens array 230.

Although an example of using one camera is described herein for convenience of description, the disclosure is not limited thereto, and modifications such as photographing using a plurality of cameras may also be made.

FIG. 3 is a diagram illustrating a method of obtaining a light field image, according to an embodiment.

Referring to FIG. 3, a plurality of cameras 300 may obtain a light field image by photographing an object 310. According to an embodiment, the plurality of cameras 300 may be arranged in a uniform distribution. For example, as shown in FIG. 3, the plurality of cameras 300 may be arranged at regular intervals in a 5×5 arrangement.

The plurality of cameras 300 may obtain a plurality of light field images captured at different viewpoints by photographing the object 310. For convenience of description, although an example of using 25 cameras in a 5×5 arrangement is described herein, the disclosure is not limited thereto, and various arrangements may be made.

FIG. 4 is a diagram illustrating a depth map according to an embodiment.

Referring to FIG. 4, a light field image including a plurality of objects 410 and 420 may be captured by using a plurality of cameras 400. FIG. 4 illustrates an example of using a plurality of cameras as illustrated in FIG. 3, but the disclosure is not limited thereto, and a light field image captured at different viewpoints may be obtained by using a camera as illustrated in FIG. 2.

For convenience of description, a first camera 401 may be a camera arranged in a first row and a first column from among the plurality of cameras 400, a second camera 402 may be a camera arranged in a second row and a first column from among the plurality of cameras 400, and a distance d1 between the plurality of cameras 400 and the first object 410 may be smaller than a distance d2 between the plurality of cameras 400 and the second object 420.

The first camera 401 may be arranged higher than the second camera 402, and thus, locations of the first object 410 and the second object 420 in an image captured by the first camera 401 may be relatively lower than locations of the first object 410 and the second object 420 in an image captured by the second camera 402.

In addition, the distance d1 may be less than the distance d2, and thus, a change in location of the first object 410 photographed by the first camera 410 and the second camera 420 may be greater than a change in location of the second object 420 photographed by the first camera 410 and the second camera 420. In other words, a location of a relatively distant object may be less changed in an image captured by the plurality of cameras 400, and a location of a relatively close object may be greatly change in an image captured by the plurality of cameras 400. For example, even when a location of the first object 410 photographed by the second camera 402 moves downwards by 2 pixels from a location of the first object 410 photographed by the first camera 401, a location of the second object 420 photographed by the second camera 402 may move downwards by 1 pixel from a location of the second object 420 photographed by the first camera 401.

According to an embodiment, a depth map of depth information of an object may be generated based on the degree of movement of pixels in images captured at different viewpoints. Compression efficiency may be increased by arranging pixels of each image having similar pixel values close to one another by using a depth map described above.

According to an embodiment, a depth map may be generated by identifying a second pixel of a second main image corresponding to a first pixel of a first main image and generating the depth map based on a difference between a location of the first pixel and a location of the second pixel.

According to an embodiment, each value of the depth map may not be an integer. According to an embodiment, an operation of generating a depth map may further include an operation of adjusting the depth map to include only a value of an integer. Convenience in alignment, processing, or calculation may be achieved by adjusting the depth map to include only the value of the integer.

FIG. 5 is a diagram illustrating a method of generating a light field prediction image based on a main image, according to an embodiment.

Referring to FIG. 5, 21 prediction images 520 captured at different viewpoints may be generated by using four main images 510 from among 25 images captured at different viewpoints.

Even when a plurality of images are captured at different viewpoints, residual images may be predicted based on some of the captured images when the viewpoints at which the plurality of images are captured are uniformly arranged. According to an embodiment, the main images 510 may be four images at an edge, and the prediction images 520 may be generated by using the main images 510.

According to an embodiment, the prediction images 520 may be generated by using a predetermined algorithm or may be generated by using an AI model trained to generate a prediction image based on a main image.

FIG. 6 is a diagram illustrating a method of generating a residual image, according to an embodiment.

Referring to FIG. 6, a residual image 630 may be generated based on a difference between a light field original image 610 and a light field prediction image 620.

According to an embodiment, a pixel value of the residual image 630 may be calculated as a difference between a pixel value of the light field original image 610 and a pixel value of the light field prediction image 620, and thus may be positive number of a negative number.

According to an embodiment, the pixel value of the residual image 630 may correspond to the difference between the pixel value of the light field original image 610 and the pixel value of the light field prediction image 620, but may have an offset value added thereto to be expressed as an unsigned integer. For example, when the pixel value of the light field original image 610 and the pixel value of the light field prediction image 620 are the same as each other, the pixel value of the residual image 630 may be 127 rather than 0.

According to an embodiment, a main image 625 of the light field prediction image 620 may be obtained by encoding and decoding a main image 615 of the light field original image 610. In the present example, a main image 635 of the residual image 630, may represent a residual due to encoding and decoding.

According to an embodiment, the main image 625 of the light field prediction image 620 may be the main image 615 of the light field original image 610. In the present example, the main image 625 of the light field prediction image 620 and the main image 615 of the light field original image 610 are not different from each other, and thus, the main image 635 of the residual images 630 may represent 0 or may refer to 127 for representing an unsigned integer value.

FIG. 7 is a diagram illustrating a structure of a micro image according to a related art.

Referring to FIG. 7, a micro image 760 may be generated based on a light field image 700.

According to an embodiment, the light field image 700 may be expressed on a u-v plane in correspondence to a viewpoint at which an image is captured. For example, a u-axis may refer to a location of a camera in a horizontal direction in which the light field image 700 is captured, and a v-axis may refer to a location of the camera in a vertical direction in which the light field image 700 is captured.

FIG. 7 illustrates an example of the light field image 700 captured at viewpoints of 5×5. From among the light field image 700, an image arranged at an upper left may be expressed as (u, v)=(1, 1), and an image arranged at a lower right may be expressed as (u, v)=(5, 5).

Each light field image 710 may be expressed on an s-t plane. For example, an s-axis may refer to a pixel location of each image in the horizontal direction, and a t-axis may refer to a pixel location of each image in the vertical direction. For example, for a light field image located in a third row and a third column, a method of expressing coordinates corresponding to 120 pixels in the horizontal direction and 180 pixels in the vertical direction may be (u, v, s, t)=(3, 3, 120, 180).

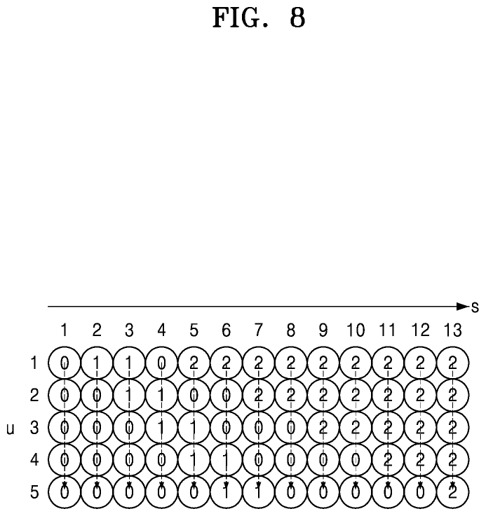

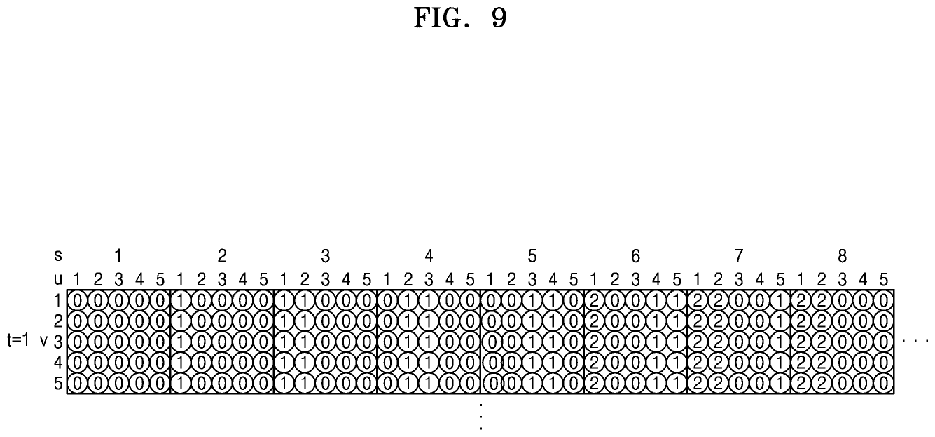

The light field image 700 may refer to an image in which a plurality of images expressed on the s-t plane are arranged on the u-v plane, and the micro image 760 may refer to an image in which a plane 750 on which a particular pixel of the light field image 700 is expressed on the u-v plane is arranged on the s-t plane. The method of generating a micro image, according to the related art, is described below in more detail with reference to FIGS. 8 and 9.

FIG. 8 is a diagram illustrating a method of generating a micro image, according to a related art.

According to an embodiment, a micro image may be generated by collecting pixel values of each coordinate (s, t) of a light field image so that the pixel values are continuously located. Referring to FIG. 8, when v=3 and t=1, the micro image may be an epipolar plane image (EPI) which represents pixel values on a s-u plane.

Each circle may correspond to one pixel, and a number shown inside each circle may be a gradient of an EPI. A value of 0 inside a circle may indicate that a gradient of an EPI is 0 and a corresponding pixel is not moved according to an image. A value of 1 (or 2) inside a circle may indicate that a gradient of an EPI is 1 (or 2) and a corresponding pixel is moved by 1 (or 2) in each image.

According to an embodiment, a gradient of an EPI may indicate the degree of movement of a corresponding pixel in each image. A pixel having a gradient of 0 in FIG. 8 may correspond to a pixel at the same location even when a value of u increases (i.e., even in the case of an image present on the right side of a corresponding image on the u-v plane). For example, a pixel corresponding to (s, u)=(1, 1) may have the same value of s and correspond to a pixel corresponding to (s, u)=(1, 2) in which u is greater by 1. In other words, a pixel corresponding to (s, u) and a pixel corresponding to (s, u)=(1, 2) may refer to pixels of the same object. In more detail, for example, a pixel corresponding to (s, u)=(1, 1) and a pixel corresponding to (s, u)=(1, 2) may be pixels of the same portion of the same object.

A pixel having a gradient of 1 may correspond to a pixel at a location at which s of a next image is increased by 1 (i.e., a value of u is increased by 1). For example, a pixel corresponding to (s, u)=(2, 1) may correspond to a pixel corresponding to (s, u)=(3, 2). Similarly, a pixel having a gradient of 2 may correspond to a pixel at a location at which u of a next image (i.e., an image in which u is increased by 1) is increased by 2. For example, a pixel having (s, u)=(5, 1) may correspond to a pixel having (s, u)=(7, 2).

According to an embodiment, a value of the depth map 125 of FIG. 1 may be a gradient of an EPI.

A micro image as shown in FIG. 9 may be generated by arranging respective pixels on the s-u plane shown in FIG. 8 in a direction indicated by an arrow. For convenience of description, v=3 and t=1 are described as examples, but the same method may be used for other (v, t).

FIG. 9 is a diagram illustrating a method of generating a micro image, according to a related art.

FIG. 9 illustrates an example micro image in which pixel values at locations (s, t) are arranged according to (u, v).

The micro image according to the related art may be generated by reversely arranging a u-v plane and an s-t plane of a light field image. In other words, the light field image may be arranged such that the s-t plane corresponds to the u-v plane, and the micro image may be arranged such that the u-v plane corresponds to the s-t plane.

Although FIG. 9 only illustrates that t is 1 and s is less than or equal to 8, but t may be greater than or equal to 2, s may be greater than or equal to 9, and ranges thereof may be determined based on a size of the micro image.

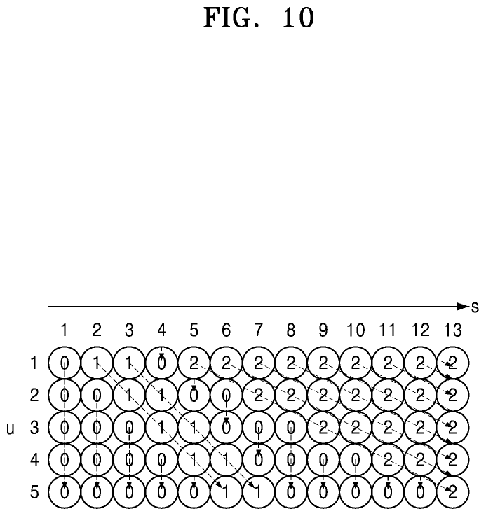

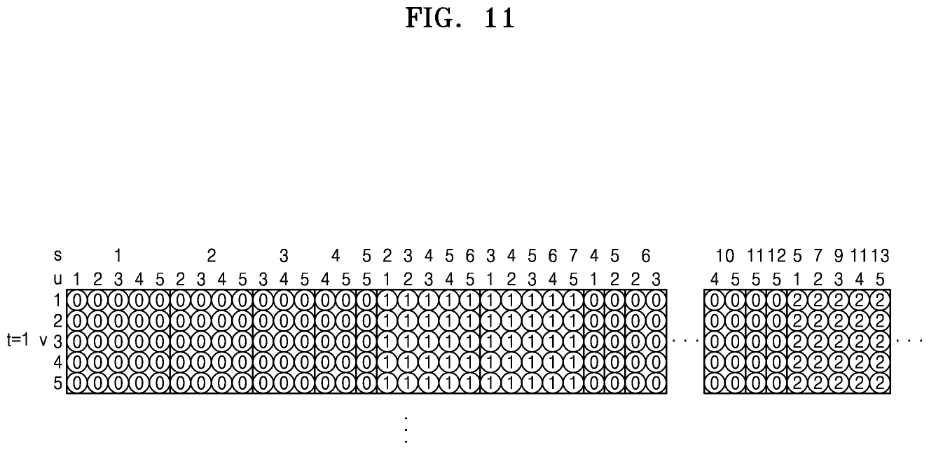

The methods of generating a micro image, according to the related arts, are described above with reference to FIGS. 7 to 9, and a method of generating a micro image, according to an embodiment, is described below with reference to FIGS. 10 and 11 which are described blow.

FIG. 10 is a diagram illustrating a method of generating a micro image, according to an embodiment.

Referring to FIG. 10, a micro image according to an embodiment may be generated by using the same EPI as an EPI shown in FIG. 8. Descriptions of an image and values inside pixels, shown in FIG. 10, may be understood in the same manner as in FIG. 8, and thus are omitted herein.

According to an embodiment, a micro image may be generated by arranging a light field image based on a value of a depth map of each pixel. For example, in the micro image, a pixel arranged on the right side may be determined based on a gradient of a pixel included in a light field image.

According to an embodiment, when a gradient of a reference pixel is 0, a pixel having the same value of s as the reference pixel and having a value of u greater by 1 than the reference pixel may be arranged on the right side of the reference pixel. For example, a pixel corresponding to (s, u)=(1, 1) may be arranged on the right side of a pixel corresponding to (s, u)=(1, 1) of FIG. 10.

According to an embodiment, when the gradient of the reference pixel is 1, a pixel having a value of s greater by 1 than the value of s of the reference pixel and a value of u greater by 1 than the value of u of the reference pixel may be arranged on the right side of the reference pixel. For example, a pixel corresponding to (s, u)=(3, 2) may be arranged on the right side of a pixel corresponding to (s, u)=(2, 1) of FIG. 10.

According to an embodiment, when the gradient of the reference pixel is 2, a pixel having a value of s greater by 2 than the value of s of the reference pixel and a value of u greater by 1 than the value of u of the reference pixel may be arranged on the right side of the reference pixel. For example, a pixel corresponding to (s, u)=(7, 2) may be arranged on the right side of a pixel corresponding to (s, u)=(5, 1) of FIG. 10. According to an embodiment, a micro image as shown in FIG. 11 may be generated by arranging a light field image based on a value of a depth map.

For convenience of description, the description is given based on an EPI, but a micro image may also be generated based on a pixel value of a light field image without generating a separate EPI.

FIG. 11 is a diagram illustrating a method of generating a micro image, according to an embodiment.

Referring to FIG. 11, based on a value of a depth map, a micro image, in which pixels having the same gradient are arranged adjacent to each other, may be generated. Compared to the micro image of FIG. 9 generated by the method of FIG. 8, the micro image of FIG. 11 generated by the method of FIG. 10 has pixels that have the same gradient and are adjacent to each other.

Having the same gradient may indicate one object. In general, an error between an original image and a predicted image occurs greatly at a boundary portion of an object. Therefore, when a micro image is generated based on the value of the depth map, pixels of a residual image having similar values may be arranged adjacent to one another. Pixels having similar residual values may be arranged adjacent to each other, and thus, compression may be more efficient.

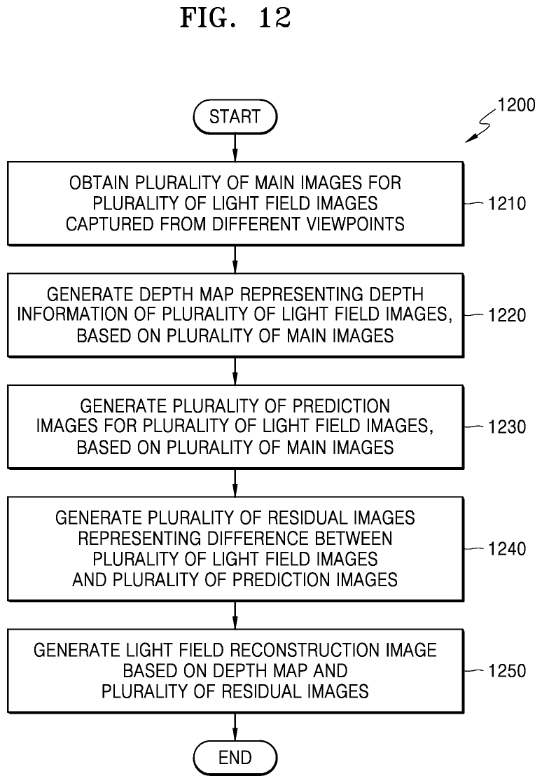

FIG. 12 is a flowchart of an image processing method according to an embodiment.

Referring to FIG. 12, an image processing method 1200 may start with operation 1210. According to an embodiment, the image processing method 1200 may be performed by the image processing apparatus 100 of FIG. 1.

In operation 1210, the image processing method 1200 may include an operation of obtaining a plurality of main images for a plurality of light field images captured from different viewpoints. According to an embodiment, the plurality of main images may be obtaining by encoding and decoding some of the plurality of light field images.

In operation 1220, the image processing method 1200 may include an operation of generating a depth map representing depth information of the plurality of light field images, based on the plurality of main images.

According to an embodiment, the image processing method 1200 may include: an operation of identifying a second pixel of a second main image corresponding to a first pixel of a first main image; and an operation of generating the depth map based on a difference between a location of the first pixel and a location of the second pixel. Each of the first main image and the second main image may be one of the plurality of main images.

According to an embodiment, the image processing method 1200 may further include an operation of adjusting a value of the depth map to an integer. For example, when the value of the depth map is 1.12, the value of the depth map may be adjusted to 1, or when the value of the depth map is 0.13, the value of the depth map may be adjusted to 0.

In operation 1230, the image processing method 1200 may include an operation of generating a plurality of prediction images for the plurality of light field images, based on the plurality of main images.

In operation 1240, the image processing method 1200 may include an operation of generating a plurality of residual images representing a difference between the plurality of light field images and the plurality of prediction images.

In operation 1250, the image processing method 1200 may include an operation of generating a micro image based on the depth map and the plurality of residual images.

According to an embodiment, the image processing method 1200 may further include: an operation of generating a synthesized image by arranging the plurality of residual images to correspond to different viewpoints at which the plurality of light field images are captured; and an operation of generating the micro image by arranging the synthesized image by using the depth map.

According to an embodiment, the image processing method 1200 may further include an operation of performing a horizontal arrangement indicating an arrangement between pixels present in the same row of the synthesized image. For example, as shown in FIGS. 10 and 11, an arrangement between pixels having the same values of v and t may be referred to as a horizontal arrangement.

According to an embodiment, the image processing method 1200 may further include an operation of performing a vertical arrangement indicating an arrangement between pixels present in the same column of the synthesized image. For example, as opposed to the horizontal arrangement, an arrangement between pixels having the same values of u and s may be referred to as a vertical arrangement.

According to an embodiment, the image processing method 1200 may further include an operation of encoding the micro image. According to an embodiment, the image processing method 1200 may further include an operation of encoding a plurality of original main images corresponding to the plurality of main images, from among the plurality of light field images. According to an embodiment, the image processing method 1200 may further include an operation of transmitting information regarding the encoded micro image and information regarding the encoded original main images.

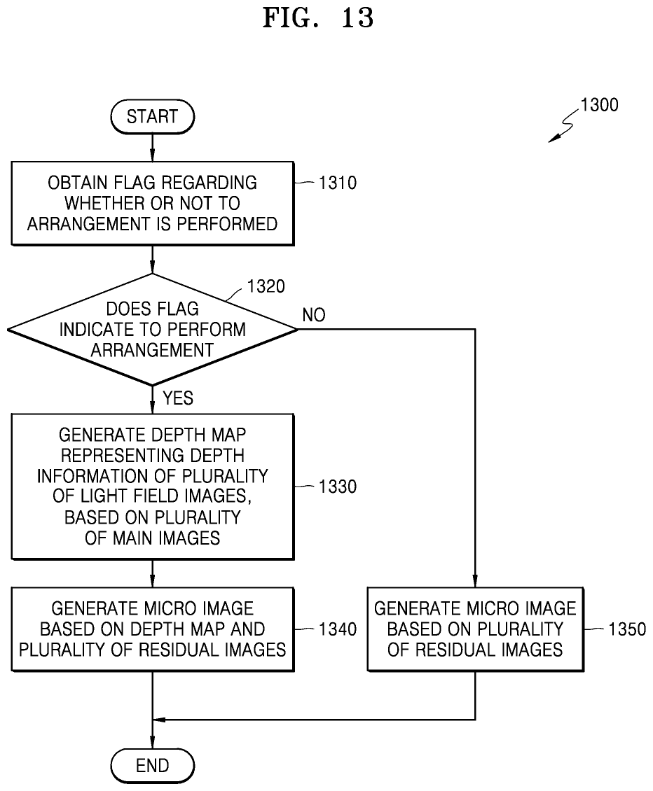

FIG. 13 is a flowchart of a method of generating a micro image based on a flag, according to an embodiment.

Referring to FIG. 13, a micro image generating method 1300 may start with operation 1310. According to an embodiment, the micro image generating method 1300 may be performed by the image processing apparatus 100 of FIG. 1.

In operation 1310, the micro image generating method 1300 may obtain a flag regarding whether or not an arrangement is performed. The flag may be obtained by receiving, from an external electronic apparatus, information regarding the flag or by determining the flag according to a predetermined condition.

In operation 1320, the micro image generating method 1300 may include an operation of identifying whether or not the flag indicates to perform the arrangement. When the flag indicates to perform the arrangement, the micro image generating method 1300 proceeds to operation 1330. When the flag indicates not to perform the arrangement, the micro image generating method 1300 proceeds to operation 1350.

In operation 1330, the micro image generating method 1300 may include an operation of generating a depth map representing depth information of a plurality of light field images, based on a plurality of main images. According to an embodiment, operation 1330 may correspond to operation 1220 of FIG. 12.

In operation 1340, the micro image generating method 1300 may include an operation of generating a micro image based on the depth map and a plurality of residual images. According to an embodiment, operation 1330 may correspond to operation 1250 of FIG. 12.

In operation 1350, the micro image generating method 1300 may generate the micro image based on the plurality of residual images. According to an embodiment, when the flag indicates that the depth map is not used, the micro image may be generated in the same method as the related arts of FIGS. 8 and 9. By determining whether or not to the depth map is used, based on the flag, an effect of reducing throughput needed to generate the depth map and generate the micro image based on the depth map may be obtained. When gradients of all objects is 0, for example, in the case of a landscape painting in which all objects are very far away, a depth map does not need to be generated, and thus, the effect of reducing throughput may be obtained.

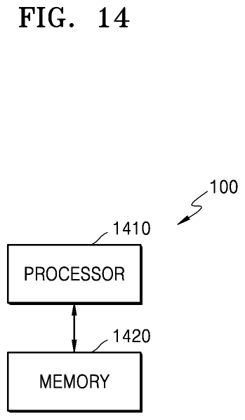

FIG. 14 is a block diagram illustrating a structure of an image processing apparatus according to an embodiment.

Referring to FIG. 14, an image processing apparatus 100 according to an embodiment may include a processor 1410 and a memory 1420.

The processor 1410 according to an embodiment may control overall operation of the image processing apparatus 100. The processor 1410 according to an embodiment may execute one or more programs stored in the memory 1420.

The memory 1420 according to an embodiment may store various types of data, programs, or applications for driving and controlling the image processing apparatus 100.

A program stored in the memory 1420 may include one or more instructions. The program (the one or more instructions) or an application stored in the memory 1420 may be executed by the processor 1410.

The processor 1410 according to an embodiment may include at least one of a central processing unit (CPU), a graphic processing unit (GPU), and a video processing unit (VPU). Alternatively, according to an embodiment, the processor 1410 may be implemented in the form of a system on chip (SoC) into which at least one of the CPU, the GPU, and the VPU is integrated. Alternatively, the processor 1410 may further include a neural processing unit (NPU).

The processor 1410 according to an embodiment may generate a micro image from a light field original image by using the main image obtainer 110, the depth map generator 120, the light field prediction image generator 130, the residual image generator 140, and the micro image generator 150.

The processor 1410 may obtain a main image based on the light field original image. According to an embodiment, the main image may be an image obtained by encoding and decoding at least a portion of the light field original image. A method of obtaining the light field original image is described above in detail with reference to FIGS. 2 and 3, a method of obtaining the main image is described above in detail with reference to FIGS. 1 and 12, and thus detailed descriptions thereof are omitted.

The processor 1410 may generate a depth map related to depth information of the main image, based on the main image. According to an embodiment, the depth information may be a gradient value of an EPI corresponding to each pixel. A method of generating a depth map is described above in detail with reference to FIGS. 1, 4, and 12, a detailed description thereof is omitted.

The processor 1410 may generate a light field prediction image based on the main image. According to an embodiment, the light field prediction image may be generated by using a predetermined algorithm or AI for generating a light field prediction image. A method of generating a light field prediction image is described above in detail with reference to FIGS. 1, 5, and 12, and thus, a detailed description thereof is omitted.

The processor 1410 may generate a plurality of residual images indicating a difference between a plurality of light field images and a plurality of prediction images. A method of generating a residual image is described above in detail with reference to FIGS. 1, 6, and 12, and thus a detailed description thereof is omitted.

The processor 1410 may generate a micro image based on the depth map and the plurality of residual images. According to an embodiment, the micro image may be generated by arranging pixels of the plurality of residual images based on corresponding values of the depth map. A method of generating a micro image is described above in detail with reference to FIGS. 1 and 7 to 13, and thus a detailed description thereof is omitted.

Meanwhile, the block diagram of the image processing apparatus 100 illustrated in FIG. 14 is a block diagram for an embodiment. Each component of the block diagram may be integrated, added, or omitted according to the specification of the image processing apparatus 100 to be actually implemented. In other words, as needed, two or more components may be combined into one component, or one component may be subdivided into two or more components. In addition, a function performed in each block is for describing embodiments, and a particular operation or apparatus therefor does not limit the scope of the disclosure.

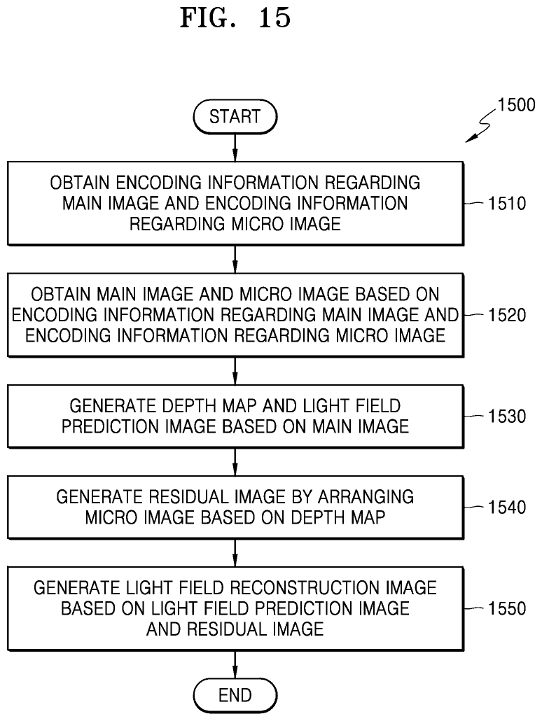

FIG. 15 is a flowchart of a method of generating a light field reconstruction image from a micro image, according to an embodiment.

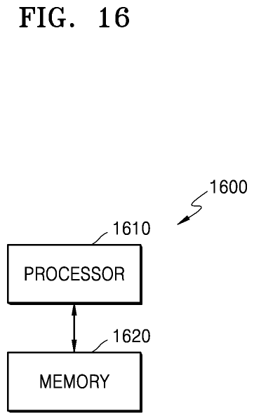

Referring to FIG. 15, an image processing method 1500 may start with operation 1510. According to an embodiment, the image processing method 1500 may be performed by an image processing apparatus 1600 of FIG. 16.

In operation 1510, the image processing method 1500 may include an operation of obtaining encoding information regarding a main image and encoding information regarding a micro image. According to an embodiment, the encoding information regarding the main image and the encoding information regarding the micro image may be information regarding encoding of the main image and the micro image generated by the image processing apparatus 100 of FIG. 1. For example, the encoding information regarding the micro image may be encoding information regarding the micro image 155 generated based on the residual image 145 of FIG. 1. The image processing method 1500 may receive the encoding information from an external electronic apparatus.

In operation 1520, the image processing method 1500 may include an operation of obtaining the main image and the micro image based on the encoding information regarding the main image and the encoding information regarding the micro image. According to an embodiment, the main image and the micro image may be generated by decoding the obtained encoding information.

In operation 1530, the image processing method 1500 may include an operation of generating a depth map and a light field prediction image based on the main image. According to an embodiment, the method of generating a depth map based on a main image may correspond to operation 1220 of FIG. 12. According to an embodiment, the method of generating the light field prediction image based on the main image may correspond to operation 1230 of FIG. 12.

In operation 1540, the image processing method 1500 may include an operation of generating a residual image by arranging the micro image based on the depth map. According to an embodiment, the residual image may be generated from the micro image by inversely performing operation 1240 of FIG. 12.

In operation 1550, the image processing method 1500 may include an operation of generating a light field reconstruction image based on the light field prediction image and the residual image.

FIG. 16 is a block diagram illustrating a structure of an image processing apparatus according to an embodiment.

Referring to FIG. 16, the image processing apparatus 1600 according to an embodiment may include a processor 1610 and a memory 1620.

The processor 1610 according to an embodiment may control overall operation of the image processing apparatus 1600. The processor 1610 according to an embodiment may execute one or more programs stored in the memory 1620.

The memory 1620 according to an embodiment may store various types of data, programs, or applications for driving and controlling the image processing apparatus 1600. A program stored in the memory 1620 may include one or more instructions. The program (the one or more instructions) or an application stored in the memory 1620 may be executed by the processor 1610.

The processor 1610 according to an embodiment may include at least one of a CPU, a GPU, and a VPU. Alternatively, according to an embodiment, the processor 1610 may be implemented in the form of an SoC into which at least one of the CPU, the GPU, and the VPU is integrated. Alternatively, the processor 1610 may further include an NPU.

The processor 1610 may obtain encoding information regarding a main image and encoding information regarding a micro image. The processor 1610 may obtain the main image and the micro image based on the encoding information regarding the main image and the encoding information regarding the micro image. The processor 1610 may generate a depth map and a light field prediction image based on the main image. The processor 1610 may generate a residual image by arranging the micro image based on the depth map. The processor 1610 may generate the micro image based on the depth map and a plurality of residual images.

Meanwhile, the block diagram of the image processing apparatus 1600 illustrated in FIG. 16 is a block diagram for an embodiment. Each component of the block diagram may be integrated, added, or omitted according to the specification of the image processing apparatus 1600 to be actually implemented. In other words, as needed, two or more components may be combined into one component, or one component may be subdivided into two or more components. In addition, a function performed in each block is for describing embodiments, and a particular operation or apparatus therefor does not limit the scope of the disclosure.

An operation method of an image processing apparatus, according to an embodiment, may be implemented in the form of program instructions that may be performed through various computer units and recorded on a computer-readable medium. The computer-readable medium may include program instructions, data files, data structures, and the like alone or in combination. The program instructions recorded on the medium may be particularly designed and configured for the disclosure, or may be known to or used by those skilled in the computer software. Examples of the computer-readable recording medium include magnetic media such as hard disks, floppy disks, and magnetic tapes, optical media such as CD-ROM and DVD, magneto-optical media such as floppy disks, and hardware devices particularly configured to store and execute program instructions, such as ROM, RAM, flash memory, and the like. Examples of the program instructions include machine language code, such as those generated by a compiler, as well as high-level language code that may be executed by a computer by using an interpreter or the like.

In addition, the image processing apparatus and the operation method of the image processing apparatus, according to the disclosed embodiments, may be included and provided in a computer program product. The computer program product may be traded between a seller and a purchaser as a product.

The computer program product may include an S/W program and a computer-readable storage medium that stores the S/W program. For example, the computer program product may include products (e.g., downloadable apps) in the form of S/W programs, which are distributed electronically via manufacturers of electronic apparatus or electronic markets (e.g., Google Play Store, App Store, or the like). For electronic distribution, at least a portion of an S/W program may be stored in a storage medium or may be temporarily generated. In this case, the storage medium may be a storage medium of a server of a manufacturer, a server of an electronic market, or a relay server that temporarily stores an SW program.

The computer program product may include a storage medium of a server or a storage medium of a client device in a system including the server and the client device. Alternatively, when a third device (e.g., a smartphone), which communicates with the server or the client device, is present, the computer program product may include a storage medium of the third device. Alternatively, the computer program product may include the S/W program transmitted from the server to the client device or the third device, or from the third device to the client device.

In this case, one of the server, the client device, and the third device may execute the computer program product to perform methods according to the disclosed embodiments. Alternatively, two or more of the server, the client device, and the third device may execute the computer program product and implement, in a distributed manner, the methods according to the disclosed embodiment.

For example, the server (e.g., a cloud server, an artificial intelligence server, or the like) may execute a computer program product stored in the server to control the client device communicatively connected to the server to perform the methods according to the disclosed embodiments.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An image processing method comprising:
obtaining a plurality of main images for a plurality of light field images captured from different viewpoints;
generating a depth map representing depth information of the plurality of light field images, based on the plurality of main images;
generating a plurality of prediction images for the plurality of light field images, based on the plurality of main images;
generating a plurality of residual images representing a difference between the plurality of light field images and the plurality of prediction images; and
generating a micro image based on the depth map and the plurality of residual images.

2. The image processing method of claim 1, wherein the generating of the depth map comprises:
identifying a second pixel of a second main image corresponding to a first pixel of a first main image; and
generating the depth map based on a difference between a location of the first pixel and a location of the second pixel, wherein each of the first main image and the second main image is one of the plurality of main images.

3. The image processing method of claim 1, further comprising adjusting a value of the depth map to an integer.

4. The image processing method of claim 1, wherein the generating of the micro image comprises:
generating a synthesized image by arranging the plurality of residual images to correspond to different viewpoints at which the plurality of light field images are captured; and
generating a micro image by arranging the synthesized image by using the depth map.

5. The image processing method of claim 4, wherein the generating of the micro image by arranging the synthesized image by using the depth map comprises generating the micro image by adjusting a location of a pixel of the synthesized image based on a value of the depth map corresponding to the pixel of the synthesized image.

6. The image processing method of claim 4, wherein the generating of the micro image by arranging the synthesized image by using the depth map comprises performing a horizontal arrangement indicating an arrangement between pixels present in a same row of the synthesized image.

7. The image processing method of claim 4, wherein the generating of the micro image by arranging the synthesized image by using the depth map comprises performing a vertical arrangement indicating an arrangement between pixels present in a same column of the synthesized image.

8. The image processing method of claim 1, further comprising encoding the micro image.

9. The image processing method of claim 6, further comprising:
encoding a plurality of original main images corresponding to the plurality of main images, from among the plurality of light field images; and
transmitting information regarding the encoded micro image and information regarding the encoded original main images.

10. The image processing method of claim 1, wherein the obtaining of the plurality of main images comprises:
encoding a plurality of original main images corresponding to the plurality of main images, from among the plurality of light field images; and
obtaining the plurality of main images by decoding the plurality of encoded original main images.

11. An image processing apparatus comprising:
a memory configured to store at least one instruction; and
at least one processor operating according to the at least one instruction, wherein the at least one processor is configured to: obtain a plurality of main images for a plurality of light field images captured from different viewpoints; generate, based on the plurality of main images, a depth map representing depth information of the plurality of light field images; generate, based on the plurality of main images, a plurality of prediction images for the plurality of light field images; generate a plurality of residual images representing a difference between the plurality of light field images and the plurality of prediction images; and generate a micro image based on the depth map and the plurality of residual images.

12. The image processing apparatus of claim 11, wherein the at least one processor is configured to: identify a second pixel of a second main image corresponding to a first pixel of a first main image; and generate the depth map based on a difference between a location of the first pixel and a location of the second pixel, and each of the first main image and the second main image includes one of the plurality of main images.

13. The image processing apparatus of claim 11, wherein the at least one processor is configured to adjust a value of the depth map to an integer.

14. The image processing apparatus of claim 11, wherein the at least one processor is configured to: generate a synthesized image by arranging the plurality of residual images to correspond to different viewpoints at which the plurality of light field images are captured; and generate a micro image by arranging the synthesized image by using the depth map.

15. The image processing apparatus of claim 14, wherein the at least one processor is configured to generate the micro image by adjusting a location of a pixel of the synthesized image based on a value of the depth map corresponding to the pixel of the synthesized image.

16. The image processing apparatus of claim 14, wherein the at least one processor is configured to perform a horizontal arrangement indicating an arrangement between pixels present in a same row of the synthesized image.

17. The image processing apparatus of claim 14, wherein the at least one processor is configured to perform a vertical arrangement indicating an arrangement between pixels present in a same column of the synthesized image.

18. The image processing apparatus of claim 11, wherein the at least one processor is configured to encode the micro image.

19. The image processing apparatus of claim 16, wherein the at least one processor is configured to: encode a plurality of original main images corresponding to the plurality of main images, from among the plurality of light field images; and transmit information regarding the encoded micro image and information regarding the encoded original main images.

20. A computer-readable recording medium having recorded thereon a program for performing the method of claim 1 in a computer.
